(19) United States
(12) Patent Application Publication
(10) Pub. No.: US 2025/0370304 A1
(43) Pub. Date: Dec. 4, 2025

(54) DISPLAY DEVICE

(71) Applicant: Japan Display Inc., Tokyo (JP)

(72) Inventor: Kasumi HASE, Tokyo (JP)

(73) Assignee: Japan Display Inc., Tokyo (JP)

(21) Appl. No.: 19/199,455

(22) Filed: May 6, 2025

(30) Foreign Application Priority Data
May 29, 2024 (JP) 2024-086775

(51) Int. Cl. G02F 1/137; G02F 1/1333; G02F 1/1335; G02F 1/13363; G02F 1/1337

(52) U.S. Cl. CPC G02F 1/13725; G02F 1/133368; G02F 1/133541; G02F 1/133636; G02F 1/133773; G02F 1/13718

(57) ABSTRACT

According to one embodiment, a display device includes a transparent substrate, a display element configured to emit display light which is circularly polarized light toward the transparent substrate, a first optical element which faces the display element via the transparent substrate and is configured to diffract display light which passed through the transparent substrate, a second optical element which is spaced apart from the first optical element and is configured to diffract display light which propagated inside the transparent substrate, a dimming element which faces the second optical element via the transparent substrate and includes a guest-host liquid crystal, and a retardation film provided between the transparent substrate and the dimming element.

### CROSS-REFERENCE TO RELATED APPLICATIONS

This application is based upon and claims the benefit of priority from Japanese Patent Application No. 2024-086775, filed May 29, 2024, the entire contents of which are incorporated herein by reference.

### FIELD

Embodiments described herein relate generally to a display device.

### BACKGROUND

Recently, various types of head-mounted displays using a light guide member and a holographic optical element (which may be hereinafter simply referred to as an HOE) which diffracts display light from a display element have been considered. For example, a technique which provides a holographic diffractive optical element on each surface of the light guide member is known. The HOE provided on one surface of the light guide member diffracts display light so as to be totally reflected on the light guide member. The HOE provided on the other surface of the light guide member diffracts display light which propagates inside the light guide member so as to be emitted to the outside.

For example, in a head-mounted display which can provide augmented reality, when the intensity of external light is high, the visibility of images for the user may be reduced.

### BRIEF DESCRIPTION OF THE DRAWINGS

FIG. 1 is a diagram showing a configuration example of a display device DSP.

FIG. 2 is a diagram showing an example of the dimming element 100 shown in FIG. 1.

FIG. 3 is a diagram schematically showing an example of the section of the dimming element 100 along the A-B line of FIG. 2.

FIG. 4A is a diagram for explaining the effect of the dimming element 100 in an off state.

FIG. 4B is a diagram for explaining the effect of the dimming element 100 in an on state.

FIG. 5A is a diagram for explaining the effect of the dimming element 100 in an off state.

FIG. 5B is a diagram for explaining the effect of the dimming element 100 in an on state.

FIG. 6A is a diagram showing the measurement result of experiment 1.

FIG. 6B is a diagram showing the measurement result of experiment 2.

FIG. 7 is a diagram for explaining a configuration example of a first optical element 11 and a second optical element 12.

FIG. 8 is a diagram for explaining one of the effects of the display device DSP.

FIG. 9 is a diagram for explaining an example of the control system of the display device DSP which is applied as goggles.

FIG. 10 is a diagram for explaining an example of the control of a vertical alignment dimming element 100.

FIG. 11 is a diagram for explaining an example of the control of a horizontal alignment dimming element 100.

FIG. 12 is a diagram for explaining the matrix driving of the dimming element 100.

### DETAILED DESCRIPTION

In general, according to one embodiment, a display device comprises a transparent substrate which has a first main surface and a second main surface facing the first main surface, a display element which faces the first main surface and is configured to emit display light which is circularly polarized light toward the transparent substrate, a first optical element which faces the display element via the transparent substrate, is provided on the second main surface and is configured to diffract display light which passed through the transparent substrate, a second optical element which is spaced apart from the first optical element, is provided on the second main surface and is configured to diffract display light which propagated inside the transparent substrate, a dimming element which faces the second optical element via the transparent substrate and comprises a guest-host liquid crystal, and a retardation film provided between the transparent substrate and the dimming element.

Embodiments will be described hereinafter with reference to the accompanying drawings.

The disclosure is merely an example, and proper changes in keeping with the spirit of the disclosure, which are easily conceivable by a person of ordinary skill in the art, come within the scope of the disclosure as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the disclosure. In addition, in the specification and drawings, structural elements which function in the same or a similar manner to those described in connection with preceding drawings are denoted by like reference numbers, detailed description thereof being omitted unless necessary.

In the drawings, in order to facilitate understanding, an X-axis, a Y-axis and a Z-axis orthogonal to each other are shown depending on the need. A direction parallel to the X-axis is referred to as a first direction X. A direction parallel to the Y-axis is referred to as a second direction Y. A direction parallel to the Z-axis is referred to as a third direction Z. When various elements are viewed parallel to the third direction Z, the appearance is defined as a plan view. When terms indicating the positional relationships of two or more structural elements, such as “on”, “above” “between” and “face”, are used, the target structural elements may be directly in contact with each other or may be spaced apart from each other as a gap or another structural element is interposed between them.

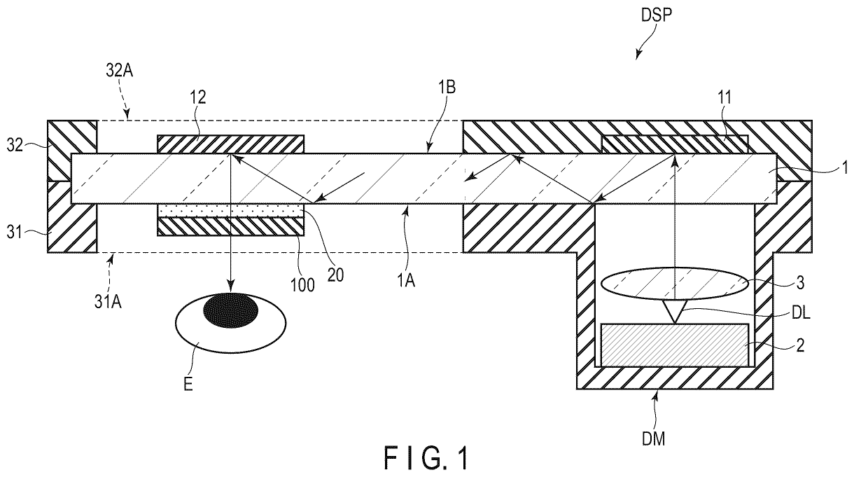

FIG. 1 is a diagram showing a configuration example of a display device DSP.

The display device DSP comprises a display module DM, a transparent substrate 1, a first optical element 11, a second optical element 12, a retardation film 20 and a dimming element 100. The display module DM comprises a display element 2 and an optical system 3. The display device DSP is held by frames 31 and 32.

The transparent substrate 1 is, for example, a glass substrate. However, the transparent substrate 1 may be a resinous substrate. The transparent substrate 1 is formed into the shape of a flat plate, and has a first main surface 1A and a second main surface 1B which faces the first main surface 1A. The first main surface 1A and the second main surface 1B are flat surfaces parallel to each other.

The display element 2 is provided on a side facing the first main surface 1A of the transparent substrate 1 and is configured to emit display light DL toward the transparent substrate 1. Display light DL is, for example, circularly polarized light. This display element 2 may be, for example, a display element which comprises a self-luminous element, such as an organic electroluminescent element or a light emitting diode, or may be a display element in which an optical switch and an illumination device are combined with each other, such as a liquid crystal panel.

The optical system 3 is provided between the display element 2 and the transparent substrate 1. This optical system 3 comprises at least one lens and is configured to collimate divergent display light DL emitted from the display element 2.

The first optical element 11 faces the display element 2 via the transparent substrate 1 and is provided on the second main surface 1B. In other words, the transparent substrate 1 is located between the display element 2 and the first optical element 11. For example, the first optical element 11 is attached to the transparent substrate 1. This first optical element 11 is configured to diffract display light DL which passed through the transparent substrate 1. In the first optical element 11, the angle of diffraction for diffracting display light DL is set such that display light DL is totally reflected inside the transparent substrate 1.

The second optical element 12 is spaced apart from the first optical element 11, faces the eye E of the user and is provided on the second main surface 1B. For example, the second optical element 12 is attached to the transparent substrate 1. This second optical element 12 is configured to diffract display light DL which propagated inside the transparent substrate 1. In the second optical element 11, the angle of diffraction for diffracting display light DL is set such that display light DL is almost vertically emitted from the first main surface 1A.

Each of the first and second optical elements 11 and 12 is, for example, an element containing a cholesteric liquid crystal. However, each of them may be a diffractive element such as a holographic optical element (HOE) which diffracts incident light at a predetermined angle of diffraction.

The dimming element 100 faces the second optical element 12 via the transparent substrate 1 and is located between the eye E of the user and the transparent substrate 1. As described later, this dimming element 100 comprises a guest-host liquid crystal and is configured to form the absorption axis of a specific direction. The absorption axis is an axis which absorbs the polarization component of a specific direction orthogonal to the traveling direction of light.

The retardation film 20 is provided between the transparent substrate 1 and the dimming element 100. For example, the retardation film 20 is attached to the transparent substrate 1, and the dimming element 100 is attached to the retardation film 20. It should be noted that the transparent substrate 1, the retardation film 20 and the dimming element 100 may be spaced apart from each other. This retardation film 20 is, for example, a λ/4-wave plate, and has the function of imparting a phase difference of λ/4 to transmitted light when the wavelength of transmitted light is λ/4. It should be noted that the retardation film 20 should be preferably configured to impart a phase difference of λ/4 to transmitted light in all of a first wavelength range including a blue component, a second wavelength range including a green component and a third wavelength range including a red component.

The frame 31 forms a space for accommodating the display module DM between the frame 31 and the transparent substrate 1. The frame 31 has an aperture 31A which faces the eye E. The retardation film 20 and the dimming element 100 are located in the aperture 31A. In the example shown in the figure, the installation area of the retardation film 20 and the dimming element 100 is less than the area of the aperture 31A. It should be noted that the retardation film 20 and the dimming element 100 may be provided over the entire area of the aperture 31A.

The frame 32 holds the transparent substrate 1 between the frame 32 and the frame 31. The frame 32 has an aperture 32A which overlaps the aperture 31A. The second optical element 12 is located in the aperture 32A. In the example shown in the figure, the area of the second optical element 12 is less than that of the aperture 32A. It should be noted that the second optical element 12 may be provided over the entire area of the aperture 32A.

In this display device DSP, display light DL emitted from the display element 2 is collimated in the optical system 3 and subsequently enters the transparent substrate 1 almost perpendicularly to the transparent substrate 1. Display light DL which passed through the transparent substrate 1 is diffracted by the first optical element 11. Display light DL which was diffracted by the first optical element 11 propagates inside the transparent substrate 1 while being totally reflected on the first main surface 1A and the second main surface 1B, and is diffracted by the second optical element 12. Display light DL which was diffracted by the second optical element 12 is almost vertically emitted from the first main surface 1A, and passes through the dimming element 100 after passing through the retardation film 20. By this configuration, the user can visually recognize the image displayed in the display element 2. Further, the user can observe the background through the display device DSP.

This display device DSP can be applied to an eyeglasses-type or goggles-type head-mounted display and can be used to provide the user with virtual reality, augmented reality and the like.

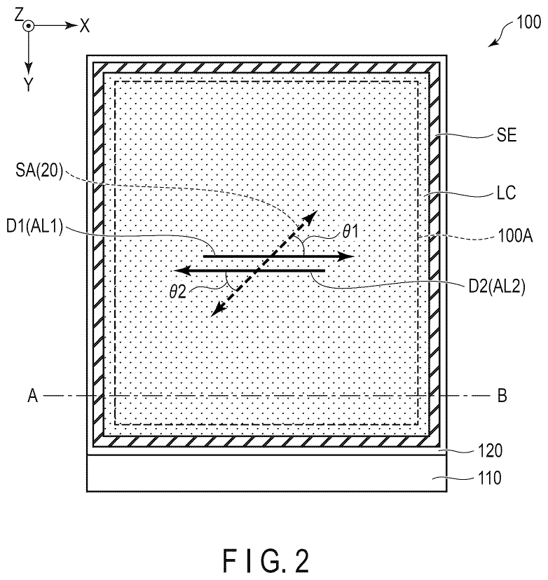

FIG. 2 is a diagram showing an example of the dimming element 100 shown in FIG. 1.

The dimming element 100 comprises a first transparent substrate 110, a second transparent substrate 120, a liquid crystal layer LC and a sealing member SE. Each of the first transparent substrate 110 and the second transparent substrate 120 is formed into the shape of a flat plate, and they overlap each other as seen in plan view.

Here, first and second directions X and Y orthogonal to each other are directions parallel to the main surface of each of the first and second transparent substrates 110 and 120. A third direction Z is the thickness direction of each of the first and second transparent substrates 110 and 120. The first transparent substrate 110 and the second transparent substrate 120 overlap each other in the third direction Z.

In the example shown in the figure, each of the first transparent substrate 110 and the second transparent substrate 120 is formed into a rectangle. However, the shapes are not limited to this example. For example, each of the first transparent substrate 110 and the second transparent substrate 120 may have any shape such as a polygon different from a rectangle, a circle, an oval or a semicircle.

The liquid crystal layer LC is located between the first transparent substrate 110 and the second transparent substrate 120, is provided over a dimming area 100A and is sealed with the sealing member SE. The first alignment treatment direction D1 of a first alignment film AL1 located between the first transparent substrate 110 and the liquid crystal layer LC and the second alignment treatment direction D2 of a second alignment film AL2 located between the second transparent substrate 120 and the liquid crystal layer LC are parallel to each other and opposite directions. In the example shown in the figure, both the first alignment treatment direction D1 and the second alignment treatment direction D2 are parallel to the first direction X. It should be noted that the alignment treatment applied to each of the first alignment film AL1 and the second alignment film AL2 may be rubbing treatment or may be photo-alignment treatment.

The slow axis SA of the retardation film 20 intersects with each of the first alignment treatment direction D1 and the second alignment treatment direction D2 in an X-Y plane defined by the first direction X and the second direction Y. For example, angle θ1 formed by the slow axis SA and the first alignment treatment direction D1 and angle θ2 formed by the slow axis SA and the second alignment treatment direction D2 are 45°.

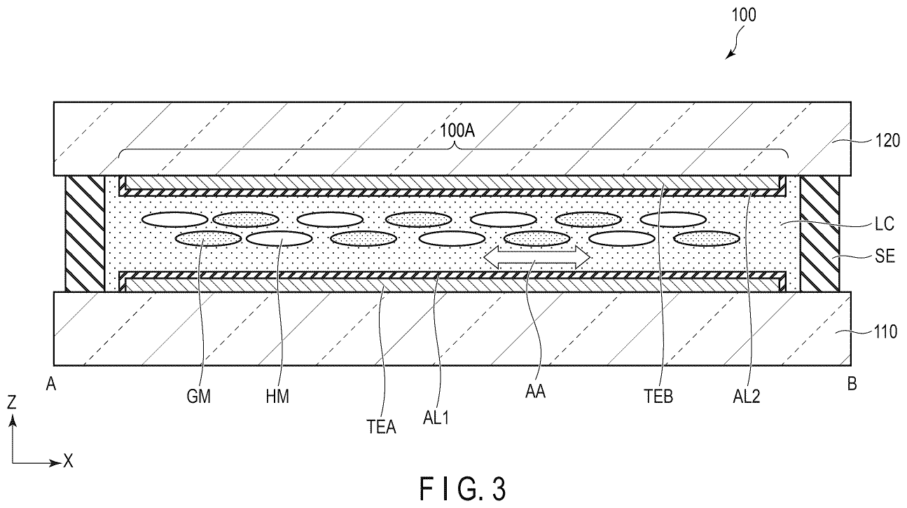

FIG. 3 is a diagram schematically showing an example of the section of the dimming element 100 along the A-B line of FIG. 2.

The first transparent substrate 110 and the second transparent substrate 120 face each other in the third direction Z. The liquid crystal layer LC is located between the first transparent substrate 110 and the second transparent substrate 120. In the dimming area 100A, a first transparent electrode TEA is located between the first transparent substrate 110 and the liquid crystal layer LC and is covered with the first alignment film AL1. A second transparent electrode TEB is located between the second transparent substrate 120 and the liquid crystal layer LC and is covered with the second alignment film AL2. The liquid crystal layer LC is in contact with the first alignment film AL1 and the second alignment film AL2.

Each of the first transparent substrate 110 and the second transparent substrate 120 is, for example, a glass substrate. However, each of them may be a resinous substrate.

Each of the first transparent electrode TEA and the second transparent electrode TEB is formed of, for example, a transparent conductive material such as indium tin oxide (ITO). Each of the first transparent electrode TEA and the second transparent electrode TEB is, for example, a sheet electrode provided over the dimming area 100A.

It should be noted that each of the first transparent electrode TEA and the second transparent electrode TEB may be a plurality of strip electrodes. In this case, a first strip electrode corresponding to the first transparent electrode TEA and a second strip electrode corresponding to the second transparent electrode TEB are provided so as to intersect each other in the dimming area 100A. The intersection of the first and second strip electrodes constitutes a segment of the dimming area 100A. The liquid crystal layer LC of each segment is driven based on the potential difference between the first strip electrode and the second strip electrode (passive matrix driving).

The first transparent electrode TEA may be a plurality of segment electrodes arranged in matrix, and the second transparent electrode TEB may be a sheet electrode provided over the dimming area 100A. In this case, each of the segment electrodes is electrically connected to an active element. In an area where one segment electrode faces the sheet electrode constitutes a segment of the dimming area 100A. The liquid crystal layer LC of each segment is driven based on the potential difference between the segment electrode and the sheet electrode (active matrix driving).

The liquid crystal layer LC comprises a guest-host liquid crystal containing dichroic dye molecules as guest molecules GM and liquid crystal molecules as host molecules HM. For example, the guest molecules GM are black dichroic dye molecules. The example of the figure shows a state in which each of the guest molecules GM and the host molecules HM is aligned in the first direction X.

The absorbance of the guest molecules GM differs between the long axis direction and the short axis direction. The guest molecules GM mainly absorb a linear polarization component parallel to the long axis direction. For this reason, the dimming area 100A can be colored based on the color of the guest molecules. When the guest molecules GM are black dichroic dye molecules, the guest molecules GM can absorb a linear polarization component parallel to the long axis and form a dark area in the dimming area 100A. The long axis direction of these guest molecules GM corresponds to the absorption axis AA in the dimming element 100. The absorption axis AA is parallel to first and second alignment treatment directions D1 and D2 shown in FIG. 2, and in the example shown in the figure, is set so as to be the first direction X.

Now, this specification explains a vertical alignment dimming element 100.

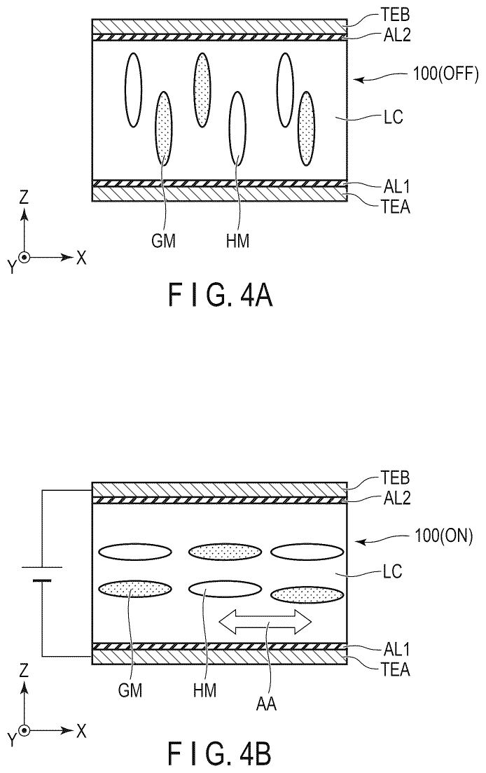

FIG. 4A is a diagram for explaining the effect of the dimming element 100 in an off state. Here, the figure shows only configurations necessary for explanation. The illustration of the other configurations is simplified or omitted.

In the dimming element 100, each of the first alignment film AL1 which covers the first transparent electrode TEA and the second alignment film AL2 which covers the second transparent electrode TEB is a vertical alignment film and has an alignment restriction force in its normal direction (in other words, the third direction Z). It should be noted that, as explained with reference to FIG. 2, alignment treatment has been applied to the first alignment film AL1 and the second alignment film AL2. The host molecules HM are liquid crystal molecules having a negative dielectric anisotropy. The guest molecules GM are black dichroic dye molecules.

No voltage is applied to the first transparent electrode TEA or the second transparent electrode TEB in an off state (OFF). At this time, the host molecules HM are initially aligned such that their long axes are parallel to the third direction Z by the alignment restriction force of the first alignment film AL1 and the second alignment film AL2. In a manner similar to that of the host molecules HM, the guest molecules GM are aligned such that their long axes are parallel to the third direction Z. Thus, both the host molecules HM and the guest molecules GM are vertically aligned. Therefore, no absorption axis is formed in the dimming element 100.

FIG. 4B is a diagram for explaining the effect of the dimming element 100 in an on state.

Voltage is applied to the first transparent electrode TEA and the second transparent electrode TEB in an on state (ON). At this time, the host molecules HM are aligned so as to intersect with the electric field formed in the liquid crystal layer LC. As described above, since alignment treatment has been applied to the first alignment film AL1 and the second alignment film AL2 such that the alignment treatment directions are parallel to the first direction X, the host molecules HM are aligned such that their long axes are parallel to the first direction X. The guest molecules GM follow the host molecules HM and are aligned such that their long axes are parallel to the first direction X. Thus, both the host molecules HM and the guest molecules GM are horizontally aligned. By this configuration, the absorption axis AA parallel to the first direction X is formed in the dimming element 100.

When light which is in a non-polarized state, such as natural light, passes through the dimming element 100 which is in an on state in the third direction Z, the guest molecules GM absorb a linear polarization component parallel to their long axis direction. In the example shown in the figure, the guest molecules GM absorb, of light which is in a non-polarized state, a linear polarization component parallel to the first direction X. Of light which is in a non-polarized state, a linear polarization component parallel to the second direction Y passes through the dimming element 100. For this reason, regarding the vertical alignment dimming element 100, the transmittance of the dimming element 100 which is in an on state is less than that of the dimming element 100 which is in an off state.

Now, this specification explains a horizontal alignment dimming element 100.

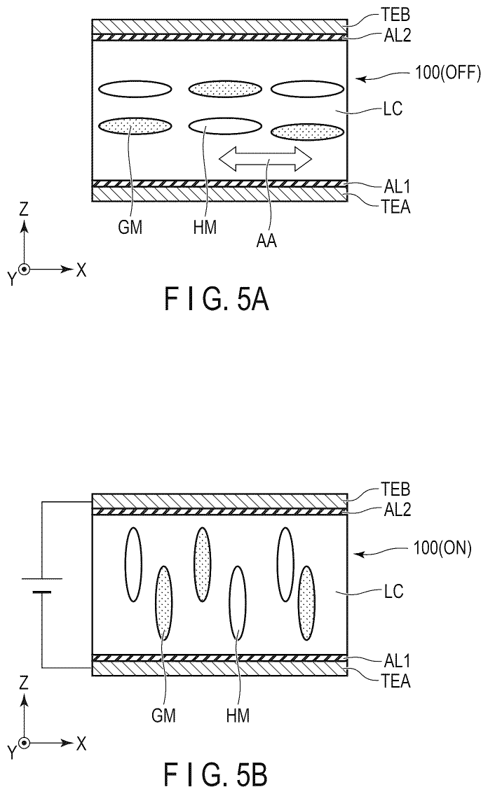

FIG. 5A is a diagram for explaining the effect of the dimming element 100 in an off state. Here, the figure shows only configurations necessary for explanation. The illustration of the other configurations is simplified or omitted.

In the dimming element 100, each of the first alignment film AL1 which covers the first transparent electrode TEA and the second alignment film AL2 which covers the second transparent electrode TEB is a horizontal alignment film and has an alignment restriction force in the first direction X. The host molecules HM are liquid crystal molecules having a positive dielectric anisotropy. The guest molecules GM are black dichroic dye molecules.

No voltage is applied to the first transparent electrode TEA or the second transparent electrode TEB in an off state (OFF). At this time, the host molecules HM are initially aligned such that their long axes are parallel to the first direction X by the alignment restriction force of the first alignment film AL1 and the second alignment film AL2. In a manner similar to that of the host molecules HM, the guest molecules GM are aligned such that their long axes are parallel to the first direction X. Thus, both the host molecules HM and the guest molecules GM are horizontally aligned. By this configuration, the absorption axis AA parallel to the first direction X is formed in the dimming element 100.

FIG. 5B is a diagram for explaining the effect of the dimming element 100 in an on state.

Voltage is applied to the first transparent electrode TEA and the second transparent electrode TEB in an on state (ON). At this time, the host molecules HM are aligned so as to be parallel to the electric field formed in the liquid crystal layer LC. In other words, the host molecules HM are aligned such that their long axes are parallel to the third direction Z. The guest molecules GM follow the host molecules HM and are aligned such that their long axes are parallel to the third direction Z. Thus, both the host molecules HM and the guest molecules GM are vertically aligned. Therefore, no absorption axis is formed in the dimming element 100.

Regarding such a horizontal alignment dimming element 100, the transmittance of the dimming element 100 which is in an off state is less than that of the dimming element 100 which is in an off state.

Now, this specification explains the optical properties of the dimming element 100. Here, an experiment in which the transmittance is measured regarding a vertical alignment dimming element 100 was conducted.

The experimental conditions are as follows. A light source, a polarizer, a dimming element and a detector are provided in this order. The light source is configured to emit illumination light which is in a non-polarized state. In a state where the light source lights up, the transmitted light of the dimming element is detected by the detector and the transmittance is measured while changing the voltage applied to the liquid crystal layer of the dimming element. The thickness of the liquid crystal layer of the used dimming element is 10 μm.

In experiment 1, the transmittance was measured on the condition that the first alignment treatment direction D1 and the second alignment treatment direction D2 are parallel to the absorption axis of the polarizer.

In experiment 2, the transmittance was measured on the condition that the first alignment treatment direction D1 and the second alignment treatment direction D2 are orthogonal to the absorption axis of the polarizer.

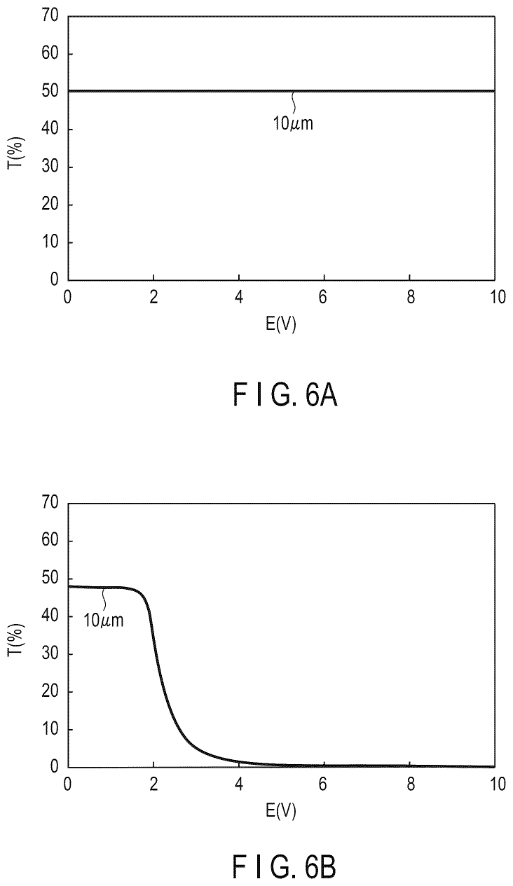

FIG. 6A is a diagram showing the measurement result of experiment 1.

FIG. 6B is a diagram showing the measurement result of experiment 2.

In FIG. 6A and FIG. 6B, the horizontal axis indicates the applied voltage E (V) of the liquid crystal layer, and the vertical axis indicates the transmittance T (%).

As shown in FIG. 6A, according to experiment 1, the transmittance T is almost constant regardless of the applied voltage E. Thus, it is confirmed that the absorption axis of the dimming element formed at the time of the application of voltage to the liquid crystal layer is parallel to the absorption axis of the polarizer.

As shown in FIG. 6B, according to experiment 2, the transmittance T is decreased in association with the increase in the applied voltage E. As shown in the figure, the transmittance T is less than or equal to 1% when a voltage greater than or equal to 5 V is applied. It is confirmed that, by using this dimming element, the linear polarization component of illumination light which passed through the polarizer can be sufficiently absorbed.

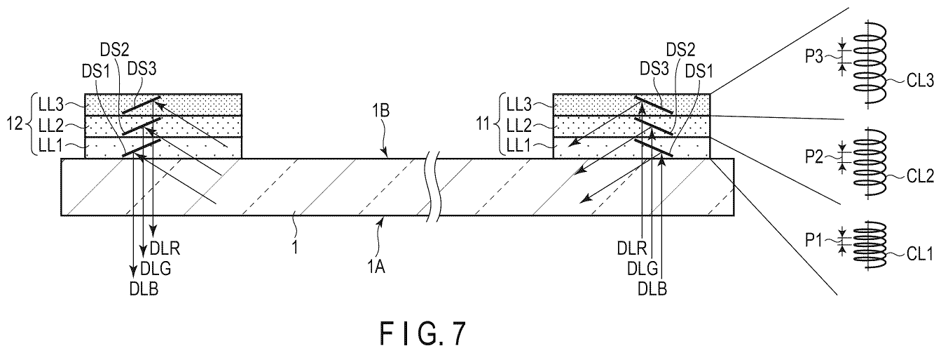

FIG. 7 is a diagram for explaining a configuration example of the first optical element 11 and the second optical element 12.

Each of the first and second optical elements 11 and 12 is a liquid crystal element which contains a cholesteric liquid crystal. The cholesteric liquid crystal contains a plurality of liquid crystal molecules which are arranged in a helical fashion twisting. It should be noted that FIG. 7 schematically shows, regarding the cholesteric liquid crystal contained in each of the first and second optical elements 11 and 12, an enlarged view of a state in which a plurality of liquid crystal molecules are arranged in a helical fashion.

This cholesteric liquid crystal is configured to diffract circularly polarized light having the same rotation direction as the twist direction and transmit circularly polarized light having a rotation direction opposite to the twist direction. The wavelength range of the circularly polarized light diffracted by the cholesteric liquid crystal is set based on the helical pitch and refractive anisotropy of the cholesteric liquid crystal.

Each of the first and second optical elements 11 and 12 comprises a first liquid crystal layer LL1, a second liquid crystal layer LL2 and a third liquid crystal layer LL3. The first liquid crystal layer LL1, the second liquid crystal layer LL2 and the third liquid crystal layer LL3 are stacked on the transparent substrate 1 in this order. These first liquid crystal layer LL1, second liquid crystal layer LL2 and third liquid crystal layer LL3 are configured to diffract display light having wavelength ranges different from each other. It should be noted that the stacking sequence of the liquid crystal layers is not limited to the example shown in the figure. The number of liquid crystal layers provided in each of the first and second optical elements 11 and 12 is not limited to three, and may be two, or may be four or greater.

The first liquid crystal layer LL1 contains a first cholesteric liquid crystal CL1. The first cholesteric liquid crystal CL1 has a first helical pitch P1. Here, the helical pitch indicates one period of the helix (in other words, the thickness parallel to the helical axis and required for a 360-degree rotation of the direction of the liquid crystal molecules arranged in a helical fashion).

The second liquid crystal layer LL2 contains a second cholesteric liquid crystal CL2. The second cholesteric liquid crystal CL2 has a second helical pitch P2. The second helical pitch P2 is different from the first helical pitch P1. Here, the second helical pitch P2 is greater than the first helical pitch P1 (P1<P2).

The third liquid crystal layer LL3 contains a third cholesteric liquid crystal CL3. The third cholesteric liquid crystal CL3 has a third helical pitch P3. The third helical pitch P3 is different from the first helical pitch P1 and the second helical pitch P2. Here, the third helical pitch P3 is greater than the second helical pitch P2 (P2<P3).

The twist directions of the first cholesteric liquid crystal CL1, the second cholesteric liquid crystal CL2 and the third cholesteric liquid crystal CL3 are the same as each other.

In the first optical element 11 having this configuration, the first liquid crystal layer LL1 is configured to diffract, of display light which vertically entered the first main surface 1A of the transparent substrate 1, display light DLB having the first wavelength range including a blue component, on a diffractive surface DS1. In a manner similar to that of the first liquid crystal layer LL1, the second liquid crystal layer LL2 is configured to diffract, of display light, display light DLG having the second wavelength range including a green component, on a diffractive surface DS2. The third liquid crystal layer LL3 is configured to diffract, of display light, display light DLR having the third wavelength range including a red component, on a diffractive surface DS3.

In the second optical element 12 having the above configuration, the first liquid crystal layer LL1 is configured to diffract display light DLB which propagates through the transparent substrate 1 on a diffractive surface DS1. In a manner similar to that of the first liquid crystal layer LL1, the second liquid crystal layer LL2 is configured to diffract display light DLG on a diffractive surface DS2. The third liquid crystal layer LL3 is configured to diffract display light DLR on a diffractive surface DS3. The beams of display light DLB, display light DLG and display light DLR diffracted by the second optical element 12 are vertically emitted from the first main surface 1A of the transparent substrate 1.

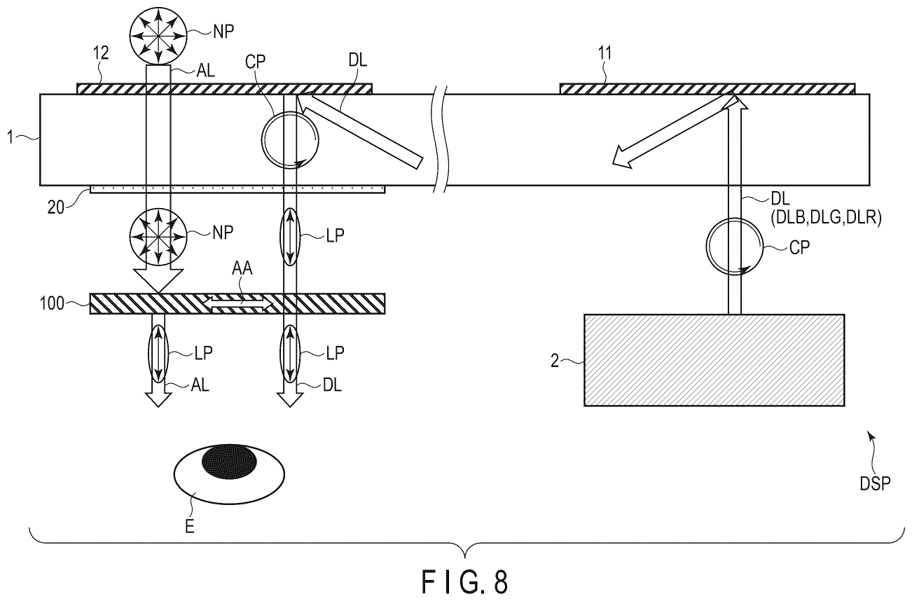

FIG. 8 is a diagram for explaining one of the effects of the display device DSP. In FIG. 8, only the configuration necessary for explanation is shown. The figure shows a polarization state in a plane orthogonal to the traveling direction of display light DL.

Display light DL emitted from the display element 2 is, for example, left-handed circularly polarized light CP, and includes, as shown in FIG. 7, display light DLB having the first wavelength range including a blue component, display light DLG having the second wavelength range including a green component and display light DLR having the third wavelength range including a red component.

Display light DL which passed through the transparent substrate 1 is diffracted by the first optical element 11. The first cholesteric liquid crystal CL1, second cholesteric liquid crystal CL2 and third cholesteric liquid crystal CL3 contained in the first optical element 11 twist in the same direction as the rotation direction of display light DL which is circularly polarized light. For this reason, as explained with reference to FIG. 7, display light DLB is diffracted by the first liquid crystal layer LL1, and display light DLG is diffracted by the second liquid crystal layer LL2, and display light DLR is diffracted by the third liquid crystal layer LL3. The diffracted display light DL propagates through the transparent substrate 1 while being totally reflected.

Display light DL which propagated through the transparent substrate 1 is diffracted by the second optical element 12. The first cholesteric liquid crystal CL1, second cholesteric liquid crystal CL2 and third cholesteric liquid crystal CL3 contained in the second optical element 12 twist in the same direction as the rotation direction of display light DL which is circularly polarized light CP. For this reason, as explained with reference to FIG. 7, display light DLB is diffracted by the first liquid crystal layer LL1, and display light DLG is diffracted by the second liquid crystal layer LL2, and display light DLR is diffracted by the third liquid crystal layer LL3. The diffracted display light DL passes through the transparent substrate 1. The polarization state of display light DL which passes through the transparent substrate 1 is circularly polarized light CP.

Display light DL which passed through the transparent substrate 1 passes through the retardation film 20. When display light DL passes through the retardation film 20, a phase difference is imparted to display light DL, and thus, display light DL is converted into linearly polarized light LP.

Display light DL which passed through the retardation film 20 passes through the dimming element 100 in which the absorption axis AA is formed. In other words, display light DL which is linearly polarized light LP is a polarization component orthogonal to the absorption axis AA. For this reason, display light DL emitted from the display element 2 reaches the eye E of the user substantially without a loss.

Meanwhile, the polarization state of external light AL which travels toward the eye E of the user from the rear of the display device DSP is non-polarized light NP. When this external light AL passes through the second optical element 12, the transparent substrate 1 and the retardation film 20, the polarization state of external light AL does not change and is maintained as non-polarized light NP. External light AL passes through the dimming element 100 in which the absorption axis AA is formed. At this time, of external light AL which is non-polarized light NP, a polarization component parallel to the absorption axis AA is absorbed in the dimming element 100. Of external light AL, a polarization component orthogonal to the absorption axis AA passes through the dimming element 100 and reaches the eye E of the user. In other words, the intensity of external light AL which reaches the eye E is decreased by approximately half by the dimming element 100. Thus, even if the display device DSP is used in a bright place where the intensity of external light AL is relatively high, the reduction in the visibility of the displayed images can be prevented.

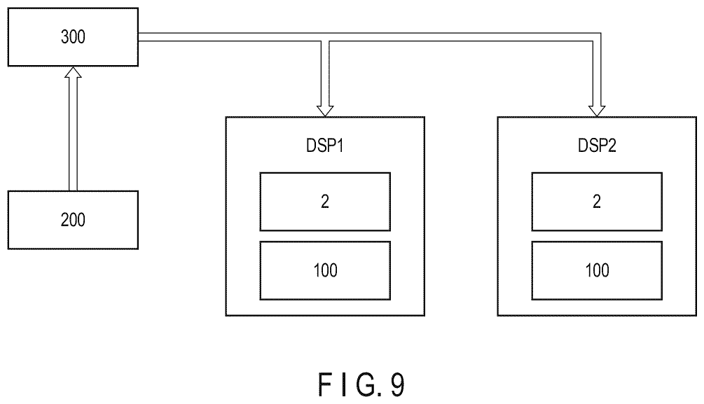

FIG. 9 is a diagram for explaining an example of the control system of the display device DSP which is applied as goggles.

For example, a display device DSP1 is provided in front of the left eye of the user. A display device DSP2 is provided in front of the right eye of the user.

An illumination sensor 200 is configured to measure the illuminance of the surrounding area of the display devices DSP1 and DSP2.

A control unit 300 is configured to control the display element 2 and dimming element 100 of each of the display devices DSP1 and DSP2.

For example, the control unit 300 drives the display element 2 and generates display light DL. The control unit 300 drives the dimming element 100 and forms the absorption axis AA as appropriate based on the illuminance measured by the illumination sensor 200.

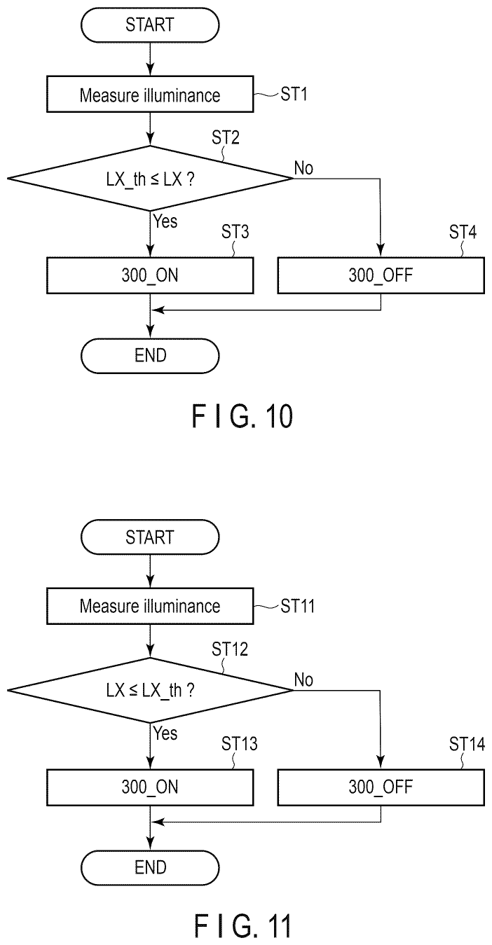

FIG. 10 is a diagram for explaining an example of the control of a vertical alignment dimming element 100.

First, the control unit 300 measures the illuminance by controlling the illumination sensor 200 (step ST1). Subsequently, the control unit 300 determines whether or not the measured illuminance LX is greater than or equal to a predetermined threshold LX_th (step ST2).

Based on determination in which the illuminance LX is greater than or equal to the predetermined threshold LX_th (YES in step ST2), the control unit 300 sets the dimming element 100 so as to be in an on state (step ST3). In other words, the control unit 300 applies voltage to each of the first transparent electrode TEA and the second transparent electrode TEB. In this manner, voltage is applied to the liquid crystal layer LC, and the guest-host liquid crystal is driven. In the liquid crystal layer LC, the host molecules HM and the guest molecules GM are horizontally aligned, and the absorption axis AA is formed in the dimming element 100. For this reason, in bright places, the intensity of external light is decreased, thereby preventing the reduction in the visibility of the displayed images.

In the meantime, based on determination in which the illuminance LX is less than the predetermined threshold LX_th (NO in step ST2), the control unit 300 sets the dimming element 100 so as to be in an off state (step ST4). In other words, the control unit 300 does not apply voltage to the first transparent electrode TEA or the second transparent electrode TEB. In the liquid crystal layer LC, the host molecules HM and the guest molecules GM are vertically aligned, and the absorption axis AA is not formed. For this reason, the background can be observed through the display devices DSP1 and DSP2 in dark places. In other words, the field of view is not blocked by the dimming element 100 in dark places.

FIG. 11 is a diagram for explaining an example of the control of a horizontal alignment dimming element 100.

First, the control unit 300 measures the illuminance by controlling the illumination sensor 200 (step ST11). Subsequently, the control unit 300 determines whether or not the measured illuminance LX is less than or equal to a predetermined threshold LX_th (step ST12).

Based on determination in which the illuminance LX is less than or equal to the predetermined threshold LX_th (YES in step ST12), the control unit 300 sets the dimming element 100 so as to be in an on state (step ST13). In other words, the control unit 300 applies voltage to each of the first transparent electrode TEA and the second transparent electrode TEB. In this manner, voltage is applied to the liquid crystal layer LC, and the guest-host liquid crystal is driven. In the liquid crystal layer LC, the host molecules HM and the guest molecules GM are vertically aligned, and the absorption axis AA is not formed. For this reason, the background can be observed through the display devices DSP1 and DSP2 in dark places.

In the meantime, based on determination in which the illuminance LX is greater than the predetermined threshold LX_th (NO in step ST12), the control unit 300 sets the dimming element 100 so as to be in an off state (step ST14). In other words, the control unit 300 does not apply voltage to the first transparent electrode TEA or the second transparent electrode TEB. In the liquid crystal layer LC, the host molecules HM and the guest molecules GM are horizontally aligned, and the absorption axis AA is formed. For this reason, in bright places, the intensity of external light is decreased, thereby preventing the reduction in the visibility of the displayed images.

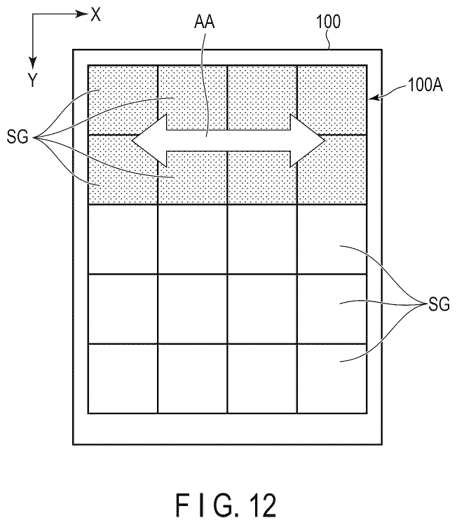

FIG. 12 is a diagram for explaining the matrix driving of the dimming element 100.

The dimming area 100A has a plurality of segments SG arrayed in matrix in the first direction X and the second direction Y. As described above, each segment SG may be configured as the intersection of the first and second strip electrodes, or may be configured as an area in which a segment electrode electrically connected to an active element faces a sheet electrode. In this manner, each segment SG is configured to individually drive the guest-host liquid crystal of the liquid crystal layer LC. This matrix driving of the dimming element 100 is performed by the control unit 300 shown in FIG. 9.

For example, as explained with reference to FIG. 10 and FIG. 11, the dimming element 100 is driven such that the absorption axis AA is formed in all of the segments SG of the dimming area 100A in bright places, and is driven such that the absorption axis AA is not formed in any segment SG of the dimming area 100A and a high transparency is imparted in dark places.

Further, the dimming element 100 is driven such that the absorption axis AA is formed when display light DL is emitted from the display element 2, and is driven such that the absorption axis AA is not formed in a state where display light DL is not emitted. Moreover, the absorption axis AA can be formed in only segments SG which overlap the image formed by display light DL by applying matrix driving to the dimming element 100.

In the example shown in the figure, in the dimming area 100A, four segments SG are arranged in the first direction X, and five segments are arranged in the second direction Y (five rows and four columns). Of the segments SG, the absorption axis AA is formed in the segments SG of the two rows and four columns of the upper side, and no absorption axis is formed in the segments SG of the three rows and four columns of the lower side.

When the segments SG of the two rows and four columns of the upper side are segments which overlap the image, the visibility of the image can be improved. Further, since the segments SG of the three rows and four columns of the lower side have a high transparency, the background can be easily observed.

As explained above, the embodiment can provide a display device and a light guide element such that the reduction in the visibility of images can be prevented.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A display device comprising:
a transparent substrate which has a first main surface and a second main surface facing the first main surface;
a display element which faces the first main surface and is configured to emit display light which is circularly polarized light toward the transparent substrate;
a first optical element which faces the display element via the transparent substrate, is provided on the second main surface and is configured to diffract display light which passed through the transparent substrate;
a second optical element which is spaced apart from the first optical element, is provided on the second main surface and is configured to diffract display light which propagated inside the transparent substrate;
a dimming element which faces the second optical element via the transparent substrate and comprises a guest-host liquid crystal; and
a retardation film provided between the transparent substrate and the dimming element.

2. The display device of claim 1, wherein
the dimming element comprises:
a first transparent substrate;
a second transparent substrate;
a liquid crystal layer which is located between the first transparent substrate and the second transparent substrate and contains the guest-host liquid crystal;
a first transparent electrode located between the first transparent substrate and the liquid crystal layer;
a first alignment film which covers the first transparent substrate;
a second transparent electrode located between the second transparent substrate and the liquid crystal layer; and
a second alignment film which covers the second transparent electrode, and
a first alignment treatment direction of the first alignment film and a second alignment treatment direction of the second alignment film are parallel to each other.

3. The display device of claim 2, wherein
the guest-host liquid crystal has a dichroic dye molecule as a guest molecule, and a liquid crystal molecule having a negative dielectric anisotropy as a host molecule,
each of the first alignment film and the second alignment film is a vertical alignment film, and
an absorption axis parallel to the first alignment treatment direction and the second alignment treatment direction is formed in a state where voltage is applied to the first transparent electrode and the second transparent electrode.

4. The display device of claim 3, further comprising:
an illumination sensor; and
a control unit which performs control such that voltage is applied to the first transparent electrode and the second transparent electrode when an illuminance measured by the illumination sensor is greater than or equal to a predetermined threshold.

5. The display device of claim 2, wherein
the guest-host liquid crystal has a dichroic dye molecule as a guest molecule, and a liquid crystal molecule having a positive dielectric anisotropy as a host molecule,
each of the first alignment film and the second alignment film is a horizontal alignment film, and
an absorption axis parallel to the first alignment treatment direction and the second alignment treatment direction is formed in a state where no voltage is applied to the first transparent electrode or the second transparent electrode.

6. The display device of claim 5, further comprising:
an illumination sensor; and
a control unit which performs control such that voltage is applied to the first transparent electrode and the second transparent electrode when an illuminance measured by the illumination sensor is less than or equal to a predetermined threshold.

7. The display device of claim 2, wherein
the retardation film is a λ/4-wave plate, and has a slow axis which intersects with each of the first alignment treatment direction and the second alignment treatment direction at an angle of 45°.

8. The display device of claim 1, wherein
the dimming element has a plurality of segments arranged in matrix, and
each of the segments is configured to individually drive the guest-host liquid crystal.

9. The display device of claim 1, wherein
each of the first optical element and the second optical element contains a cholesteric liquid crystal which twists in a same direction as a rotation direction of the circularly polarized light.

10. The display device of claim 1, wherein
each of the first optical element and the second optical element comprises:
a first liquid crystal layer which contains a first cholesteric liquid crystal having a first helical pitch;
a second liquid crystal layer which overlaps the first liquid crystal layer and contains a second cholesteric liquid crystal having a second helical pitch different from the first helical pitch; and
a third liquid crystal layer which overlaps the second liquid crystal layer and contains a third cholesteric liquid crystal having a third helical pitch different from the first helical pitch and the second helical pitch, and
twist directions of the first cholesteric liquid crystal, the second cholesteric liquid crystal and the third cholesteric liquid crystal are same as each other.
